(19) United States
(12) Patent Application Publication
(10) Pub. No.: US 2019/0306395 A1
(43) Pub. Date: Oct. 3, 2019

(54) IMAGE PICKUP DEVICE

(71) Applicant: KANTATSU CO., LTD., Yaita-shi (JP)

(72) Inventor: Masahiro HASEGAWA, Sukagawa-city (JP)

(21) Appl. No.: 16/161,874

(22) Filed: Oct. 16, 2018

(30) Foreign Application Priority Data
Oct. 16, 2017 (JP) 2017-200117

(51) Int. Cl. H04N 5/225; G02B 5/20; G03B 11/00

(52) U.S. Cl. CPC H04N 5/2258; G02B 5/208; G03B 13/36; H04N 5/2254; G03B 11/00

(57) ABSTRACT

To downsize a device, suppress occurrent and invasion of foreign objects, and obtain a visible-light image and a near-infrared light image with high quality using only one device. There is provided an imaging device comprising a optical system, an image sensor for imaging an optical image of an object passing through the optical system, and a filter arranged in an optical path from the object to the image sensor, wherein the filter comprises a first filter partially blocking the optical path and a second filter entirely blocking the optical path, the first filter shields a near-infrared light and the second filter transmits two wavelength groups of a visible-light and the near-infrared light, and the image sensor comprises a first imaging unit for forming the image of light which does not pass through the first filter and passes through the second filter, and a second imaging unit for forming the image of light which passes through both of the first filter and the second filter.

The present application is based on and claims priority of a Japanese patent application No. 2017-200117 filed on Oct. 16, 2017, the entire contents of which are hereby incorporated by reference.

### BACKGROUND OF THE INVENTION

### Field of the Invention

The present invention relates to an imaging device for imaging an optical image of an object.

### Description of the Related Art

With advancement of information and communication technology, various information security technologies have been developed. In recent years, one of biometric authentications, iris recognition has attracted attention as an advanced security technology.

The iris authentication is more difficult in counterfeiting, higher in authentication accuracy and more secure in comparison with fingerprint authentication. Therefore, the iris authentication has been widely put to practical use.

Patent Document 1 (JP2003-256819A) and Patent Document 2 (JP2006-048266A) disclose a technology for establishing both a function for imaging a near-infrared light image and a function for imaging a visible light image.

### SUMMARY OF THE INVENTION

In recent years, progress has been made in a mobile phone, PC (Personal Computer) and a tablet terminal so as to be smaller in thickness and size. However, in configurations according to the Patent Documents 1 and 2, there is provided a mechanism that a lens unit or filers are required to be slided, therefore it is difficult to downsize the device. Additionally, there is a problem that foreign objects appear in a captured image due to dust from a drive mechanism.

The present invention has been made in view of the above-described problems, and an object of the present invention is to downsize a device. Furthermore, another object of the present invention is to provide an imaging device which is capable of suppressing occurrence or invasion of foreign objects and obtaining a visible-light image and a near-infrared light image with high quality using only one device.

In order to solve the above-described problem, an imaging device according to an aspect of the present invention comprises a optical system, an image sensor for imaging an optical image of an object passing through the optical system, and a filter arranged in an optical path from the object to the image sensor, wherein the filter comprises a first filter partially blocking the optical path and a second filter entirely blocking the optical path, the first filter shields a near-infrared light and the second filter transmits two wavelength groups of a visible-light and the near-infrared light, and the image sensor comprises a first imaging unit for forming the image of light which does not pass through the first filter and passes through the second filter and a second imaging unit for forming the image of light which passes through both the first filter and the second filter.

Regarding terms used in the present specification, a visible-light is defined as a light having a wavelength range of 400 nm to 650 nm, a near-infrared light is defined as a light having the wavelength range of 800 nm to 850 nm. An optical system is a constitution which includes one or more optical lenses and in which these lenses, a light-shielding plate, a rear light-shielding ring and other optical members are combined and stored in a barrel. Furthermore, all lights mean the light in the wavelength range which an image sensor has sensitivity.

### Effect of Invention

According to one aspect of the present invention, there is provided an imaging device capable of downsizing the device. Furthermore, the imaging device has an effect for suppressing occurrence or invasion of foreign objects and obtaining a visible-light image and a near-infrared light image with high quality using only one device.

### BRIEF DESCRIPTION OF THE DRAWINGS

FIG. 1 is a cross sectional view showing a chief part of an imaging device according to an Embodiment 1 of the present invention;

FIG. 2 illustrates a relationship between an optical path of a light passing through an optical system and a first imaging unit and a second imaging unit according to an Embodiment 1 of the present invention.

FIG. 3 illustrates an example of the first imaging unit and the second imaging unit of the image sensor according to the Embodiment 1 of the present invention;

FIG. 4 illustrates a method of manufacturing a first filter according to the Embodiment 1 of the present invention;

FIG. 5 illustrates a modification 1 of the first filter according to the Embodiment 1 of the present invention;

FIG. 6 illustrates a modification 2 of the first filter according to the Embodiment 1 of the present invention;

FIG. 7 illustrates a method of manufacturing the imaging device according to the Embodiment 1 of the present invention;

FIG. 8 is a cross sectional view showing a chief part of the imaging device in which modification 2 of the first filter is used inside of the optical system.

FIG. 9 illustrates a condition which a focusing mechanism is provided in the imaging device according to the Embodiment 2 of the present invention;

FIG. 10 is a cross sectional view showing a chief part of the imaging device according to the Embodiment 2 of the present invention; and

FIG. 11 is a cross sectional view showing a chief part of the imaging device according to the Embodiment 3 of the present invention.

### DETAILED DESCRIPTION OF THE PREFERRED EMBODIMENT

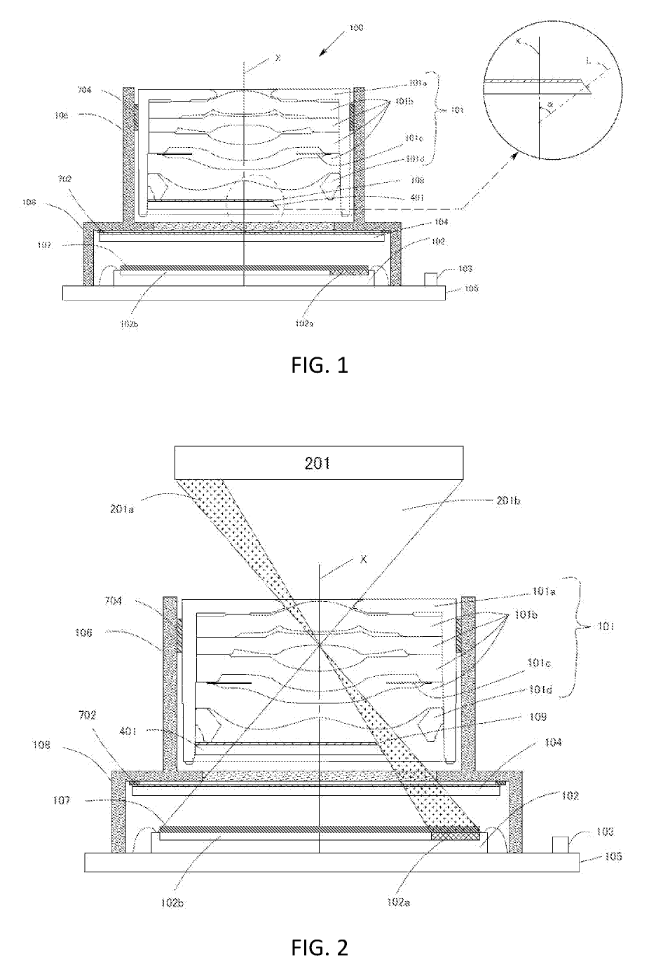

Hereinafter, the preferred embodiment of the present invention will be described referring to FIGS. 1 to 11.

For the purpose of illustration, a composition having the same function as the composition which is explained in a specified item has the same reference numerals and an explanation will be omitted.

### Embodiment 1

An Embodiment 1 according to the present invention will be described referring to FIG. 1. FIG. 1 is a cross sectional view showing a chief part of an imaging device 100 according to an Embodiment 1 of the present invention;

As shown in FIG. 1, the imaging device 100 comprises an optical system 101, a first filter 109, an image sensor 102, a signal reading unit 103, a second filter 104, a substrate 105, a holder 106, a color filter 107 and a housing 108.

The imaging device 100 is, for example, an imaging device for personal photographing used in a potable telephone apparatus with a camera and PC with a camera. The imaging device 100 is also the imaging device having authentication function, such as an iris authentication device performing personal authentication using an iris image.

The optical system 101 forms an optical image of an object by optical lenses on a first imaging unit 102a and a second imaging unit 102b of the image sensor 102. Furthermore, the optical system of the present embodiment is the optical system of a fixed focus, therefore downsizing the device can be achieved.

The first filter 109 is a near-infrared light shielding film formed on a translucent substrate 401. The first filter is arranged inside the optical system 101 so that an optical path from the object to the image sensor 102 is partially blocked. A wavelength range of the light which the first filter 109 blocks is preferably 650 nm or more, however it is not limited thereto and a lower limit of the wavelength range only has to be in a range of 600 nm to 680 nm.

The translucent substrate 401 forming the first filter 109 is arranged in a direction perpendicular to an optical axis X of the optical system 101. The translucent substrate 401 has a configuration which an area without forming the near-infrared light shielding film is cut. An inclined surface on which a normal line L intersects the optical axis X of the optical system 101 at an angle α is formed on a cut plane made by cutting the substrate. Thereby, flare occurred by refraction from the cut plane can be suppressed. The inclined surface formed on the cut plane preferably has an intersection point of the normal line L and the optical axis X of the optical system 101 located nearer the image sensor than the filter. The optical axis X referring to here is a central axis of the optical system 101 and is described by a dashed line, however does not have physical substance.

The second filer 104 transmits two wavelength groups of the visible-light and the near-infrared light, and blocks lights of other wavelengths. The second filter is located outside the optical system 101 so that the optical path from the object to the image sensor 102 is entirely blocked.

The wavelength range of the light passing through the second filter 104 is defined as 400 nm to 650 nm and 800 nm to 850 nm, however it is not limited thereto. For example, the wavelength range of the light passing through the second filter 104 may be 390 nm to 680 nm for the visible light, and 780 nm to 950 nm for the near-infrared light. Generally, the wavelength in the vicinity of 810 nm is regarded as the wavelength which is capable of effectively authenticating iris patters of any colors of eyes. According to the present embodiment, effective iris authentication is achieved by forming the image of the near-infrared light of 810 nm to 850 nm.

Relative positions of the first filter 109 and the second filter 104 are fixed against the image sensor 102. Thereby, dust is suppressed.

The image sensor 102 images the optical image of the object passing through the optical system 101. The image sensor 102 also comprises a first imaging unit 102a and a second imaging unit 102b. The visible light and the near-infrared light which does not pass through the first filter 109 and passes through the second filter 104 form the image on the first imaging unit 102a. The visible light which passes through both the first filter 109 and the second filter 104 forms the image on the second imaging unit 102b. The first imaging unit 102a is an area for forming an iris image for the iris authentication, and the second imaging unit 102b is an area for forming a visible light image. The signal reading unit 103 separately reads out video and picture signals from the first imaging unit 102a and the second imaging unit 102b. The signal reading unit 103 is arranged on the substrate 105 outside the housing 108.

The image sensor 102 is fixed on the substrate 105, and the color filter 107 is arranged on an imaging plane of the image sensor 102. The color filter 107 is configured to have a color filter having three primary colours (RGB) different in each sub-pixel of pixels so as to achieve multi-color display of the captured image by the image sensor 102.

The housing 108 is fixed on the substrate 105 so as to cover the image sensor 102, and the second filter 104 is fixed on an upper wall surface in the inside of the housing 108.

According to the present embodiment, downsizing the device can be achieved by configuration using the optical system of a fixed focus and having no moving parts achieves. Furthermore, the relative positions of the first filter 109 and the second filter 104 are fixed against the image sensor 102, therefore the dust is suppressed and occurrence or invasion of foreign objects which causes poor image quality is also suppressed.

Next, referring to FIG. 2, description will be made of relationship between the optical path of the light passing through the optical system 101 and the first imaging unit 102a and the second imaging unit 102b.

As shown in FIG. 2, the image of the object 201 is formed on the image sensor 102 passing through the optical system 101. The formed image is read out from the signal reading unit 103 as the video and picture signal. The image sensor 102 comprises the first imaging unit 102a and the second imaging unit 102b. The light ray from an area 201a of the object 201 passes through an optical lens 101b included in the optical system 101 and the second filter 104, and forms an image on the first imaging unit 102a. At this time, the light ray does not pass through the first filter 109, therefore the near-infrared light and the visible light form the image on the first imaging unit 102a. On the other hand, the light ray from an area 201b of the object 201 passes through the first filter 109 and the second filter 104, and forms the image on the second imaging unit 102b. AT this time, the near-infrared light is blocked by the first filter 109, therefore the visible light forms the image on the second imaging unit 102b. Accordingly, the image of the near-infrared light can be obtained from the first imaging unit 102a and the image of the visible light can be obtained from the second imaging unit 102b. The image sensor 102 is capable of output arbitrary different areas.

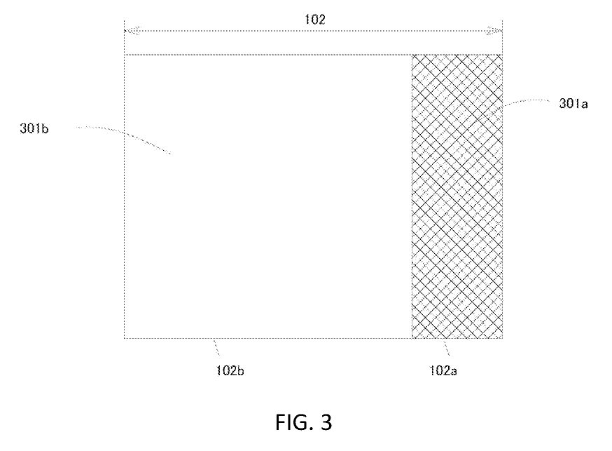

As shown in FIG. 3, the first imaging unit 102a has an iris image area 301a, and the second imaging unit 102b has a visible light image area 301b. Accordingly, one imaging device can separately output the visible light image and the iris image by dividing regions of forming the image of the image sensor 102 into two regions.

By changing a size of the first filter 109, it become possible to arbitrarily determine a size of the output image.

### [Method of Manufacturing the First Filter 109]

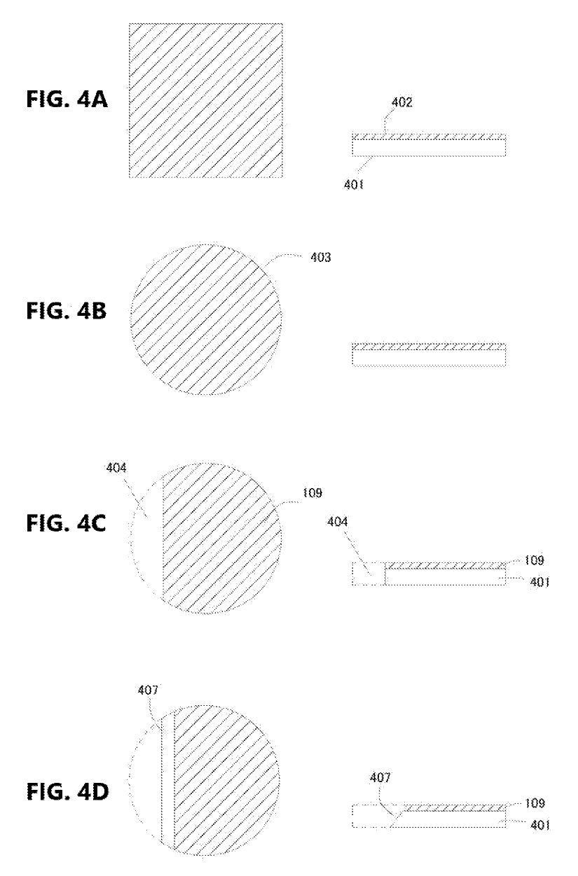

Next, the description will be made of the method of manufacturing the first filter 109 referring to FIG. 4A to 4D.

As shown in FIG. 4A, a near-infrared light shielding film 402 is formed on a glass substrate 401. The light shielding film may be prepared by spattering, evaporating and so on, but not limited thereto. Transmission wavelength may be 400 nm to 650 nm. A material of the substrate is not limited to the glass.

As shown in FIG. 4B, a circle filter 403 is prepared by making the glass substrate 401 into round shape in conformity with a predetermined size. The method of blade dicing, razor dicing and so on may be applicable, but not limited thereto.

As shown in FIG. 4C, a part of an area capable of imaging of the substrate is cut in the above-described method, and a spatial area, an area 404 for transmitting all lights is formed.

As shown in FIG. 4D, bevel processing is made on the cut plane formed by cutting the substrate so as to form the inclined surface on which the normal line intersects the optical axis X of the optical system at a predetermined angle. By forming such inclined surface, flare occurred by refraction from the cut plane can be suppressed.

### [Modification 1 of the First Filter 109]

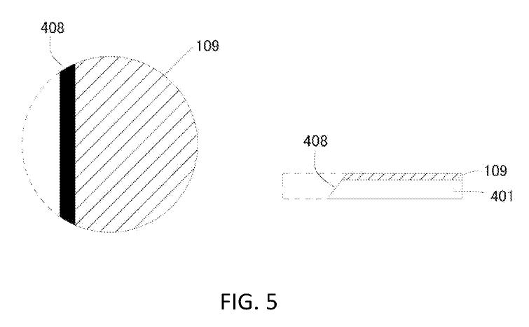

Referring to FIG. 5, description will be made of modification 1 of the first filter 109. As shown in FIG. 5, a light shielding film 408 for shielding all lights is formed on a bevel processing part 407 described referring to FIG. 4D. A method for forming the light shielding film may be dispensing or dipping, but not limited thereto. By forming the light shielding film 408, the flare occurred by refraction from the bevel processing part 407 can be suppressed. The light shielding film 408 can obtain the similar effect of the above not when it is formed not only on the bevel processing part 407 but on a cut plane prepared by cutting the substrate.

Herein, the light-shielding film for shielding all lights is defined as a film which attenuates the light until output becomes substantially zero or is regarded as zero within the wavelength range which the image sensor has sensitivity.

### [Modification 2 of the First Filter 109]

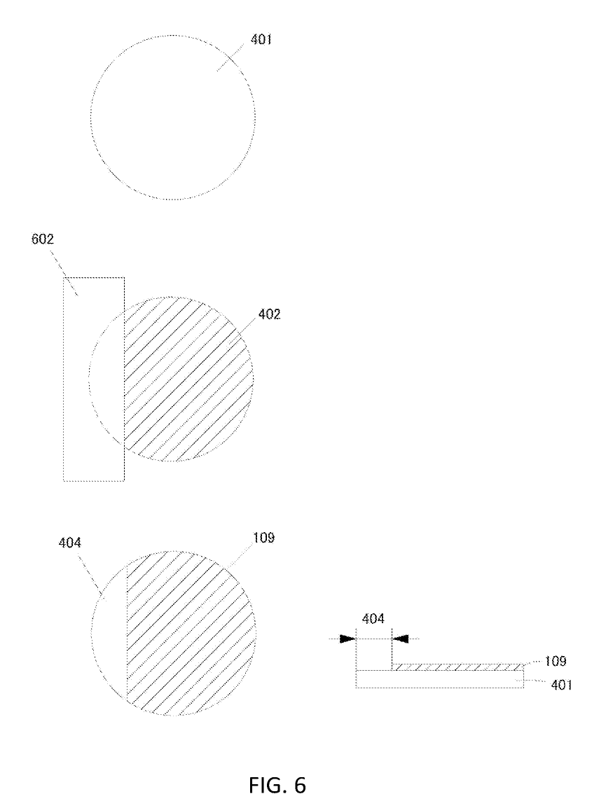

Referring to FIG. 6, description will be made of modification 2 of the first filter 109. As shown in FIG. 6, the glass substrate 401 is cut into a desirable size and shape. Next, a part of the glass substrate 401 is covered by a mask 602, and the near-infrared light shielding film 402 is formed. In the present embodiment, an area covered by the mask 602 becomes the area 404 for transmitting all lights.

### [Method of Manufacturing the Second Filter 104]

The second filter 104 is made by passing the lights of two wavelength groups, forming a film shielding light of other wavelengths, and cutting into a desirable size. Transmission wavelength may be, for example, 400 nm to 650 nm for visible light and 800 nm to 850 nm for the near-infrared light. The material of the substrate is not limited to the glass.

### [Method of Manufacturing the Imaging Device]

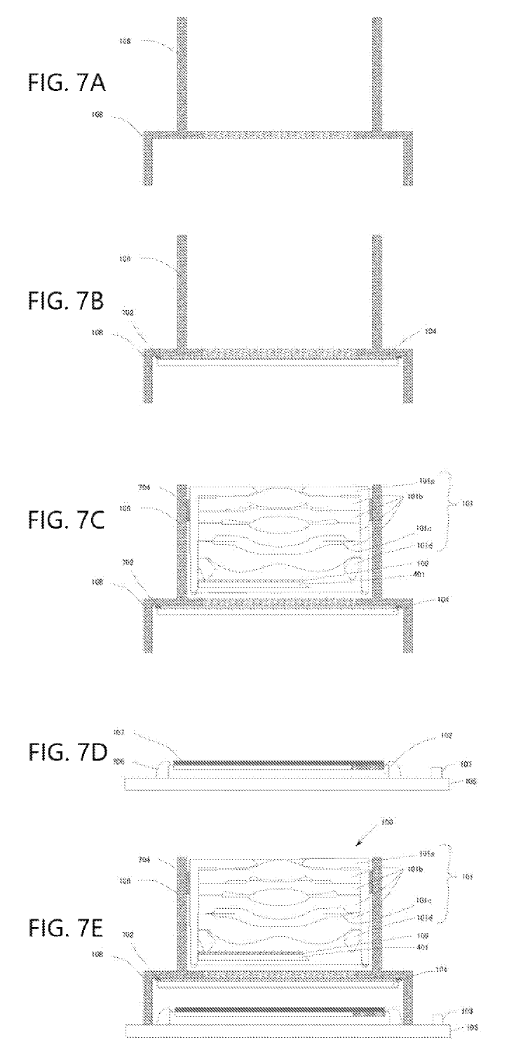

Referring to FIG. 7, description will be made of a method of manufacturing the imaging device 100 related to the embodiment 1 according to the present invention. FIG. 7A to 7D illustrate the method of manufacturing the imaging device 100.

FIG. 7A shows a holder 106 for holding the optical system 101, and the housing 108.

As shown in FIG. 7B, the filter 104 is fixed on the upper wall surface in the inside of the housing 108 using an adhesive 702. Next, as shown in FIG. 7C, the optical system 101 including the first filter 109 is fixed on the holder 106 using the adhesive 704.

Next, as shown in FIG. 7D, the image sensor 102 is fixed by die bonding on the substrate 105 on which the signal reading unit 103 (a connector) is mounted, and wire bonding 706 is made for electrically connecting the substrate 105 and the image sensor 102.

Next, the materials as shown in FIG. 7C are fixed on the substrate 105 shown in FIG. 7D using the adhesive. According to procedures shown in FIGS. 7A to 7D, the imaging device 100 as shown in FIG. 7E can be manufactured.

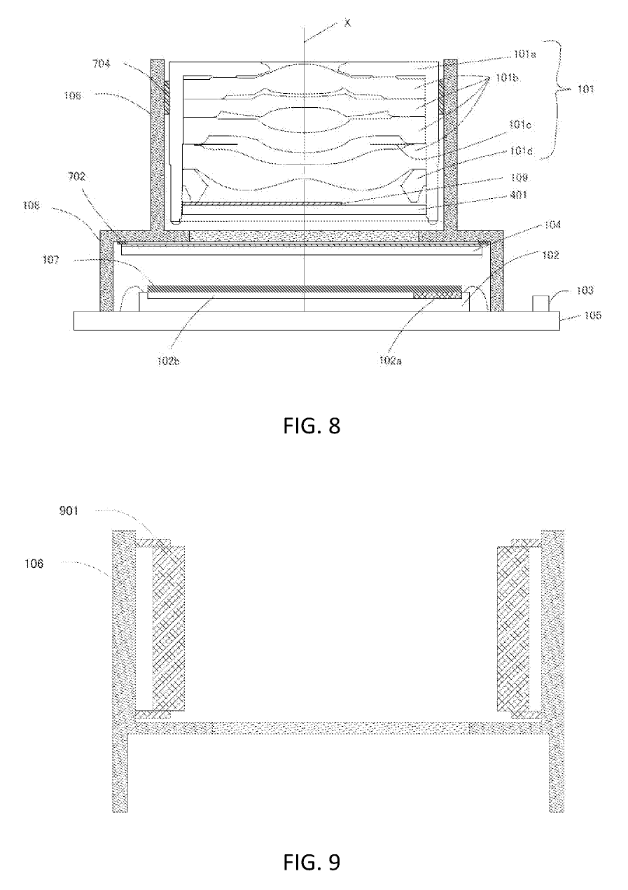

FIG. 8 is a cross sectional view showing the imaging device in which the first filter 109 formed using the mask in FIG. 6 is fixed inside the optical system 101. The first filter 109 formed using the mask in FIG. 6 is configured in circle shape without chipping of the glass substrate 401, and length of the optical path is increased by light forming the image on the first imaging unit 102a and light forming the image on the second imaging unit 102b. Therefore, taking the images in a fixed focus method is facilitated. Furthermore, the first filter 109 has an advantage to be fixed stably.

### Embodiment 2

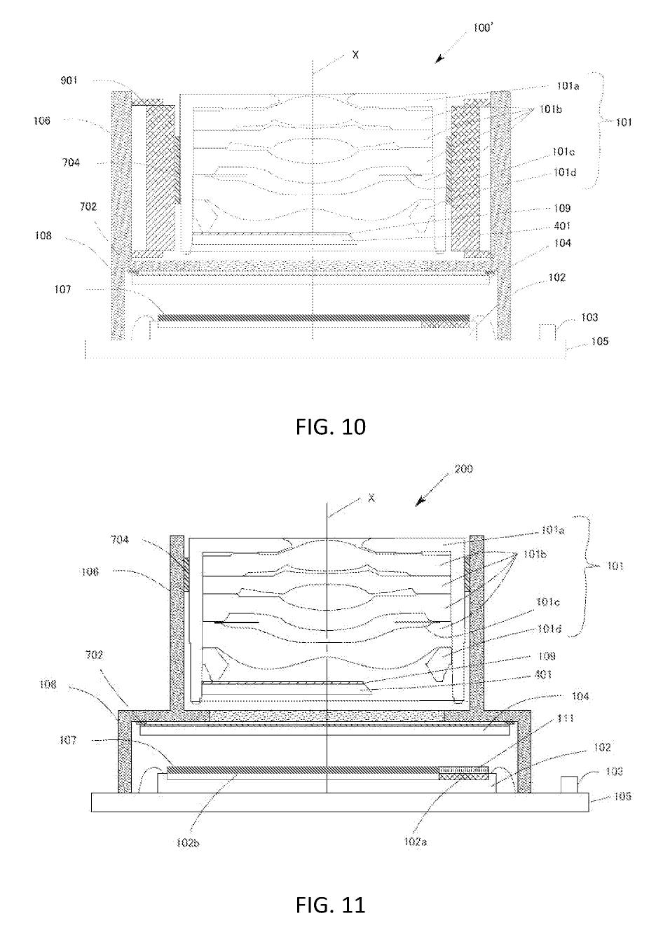

An Embodiment 2 according to the present invention will be described referring to FIGS. 9 and 10. FIG. 9 illustrates a condition which a focusing mechanism 901 is provided on the holder 106, and FIG. 10 is a cross sectional view showing a chief part of the imaging device 100′ according to the Embodiment 2 of the present invention. The imaging device 100′ according to the present embodiment is different from the above embodiment 1 because the imaging device 100′ has the focusing mechanism 901.

As shown in FIG. 9, the imaging device 100′ shown in FIG. 10 is manufactured by using the holder 106 comprising the focusing mechanism 901 and applying the similar manufacturing method to the above-described Embodiment 1. The focusing mechanism 901 may be a VCM (Voice Coil Motor) method or a ball guide method, but not limited thereto.

According to the present embodiment, a captured image is prevented from being out of focus by comprising the focusing mechanism.

### Embodiment 3

An Embodiment 3 according to the present invention will be described referring to FIG. 11. FIG. 11 is a cross sectional view showing a chief part of the imaging device 200 according to the Embodiment 3 of the present invention. The imaging device 200 according to the present embodiment is different from the above-described Embodiment 1 because the filter on the image sensor 102 is divided into two units, the first imaging unit 102a and the second imaging unit 102b.

In the imaging device 200 according to the present embodiment, a clear filter 111 for transmitting all lights is arranged on the imaging plane of the first imaging unit 102a. The color filter 107 is also arranged on the imaging plane of the second imaging unit 102b. Thereby, in an iris image area of the first imaging unit 102 on which the clear filter 111 is arranged, it becomes possible to obtain the iris image which is high in sensitivity and quality.

According to the present embodiment, it is capable of obtaining the clearer near-infrared light image.

The present invention is not limited to each embodiment as described above, and various modifications or changes can be employed without beyond the scope of the present invention. Additionally, embodiments obtained by combining technical means disclosed in each embodiment are also included in the technical scope of the present invention, and new technical features made by combining the technical means are also included in the scope of this invention.

For example, it is not essential that one or both of the first filter 109 and the second filter 104 are perpendicular to the optical axis X, and Intersecting at an angle other than a right angle may be available. Furthermore, materials of the second filter 104 and the substrate 401 are not limited to the glass, and other materials having desirable property can be applicable. According to the present invention, combination of face authentication and the iris authentication is applicable, and in this case, a stronger authentication is realized.

### DESCRIPTION OF REFERENCE NUMERALS

100, 100′, 200: imaging device
101: optical system
101a: barrel
101b: optical lens
101c: light shielding plate
101d: rear light shielding ring
102: image sensor
102a: first imaging unit
102b: second imaging unit
103: signal reading unit
104: second filter
105: substrate
106: holder
107: color filter
108: housing
109: first filter
111: clear filter
201: object
401: glass substrate
402: near-infrared light shielding film
403: cut filter
404: area for transmitting all lights
407: bevel processing
408: light shielding film
602: mask
702, 704: adhesive
706: wire bonding
901: focusing mechanism
X: optical axis
L: normal line on cut plane
α: angle of optical axis and normal line

1. An imaging device comprising,
an optical system,
an image sensor for imaging an optical image of an object passing through said optical system, and
a filter arranged in an optical path from said object to said image sensor, wherein said filter comprises a first filter partially blocking said optical path and a second filter entirely blocking said optical path, said first filter shields a near-infrared light and said second filter transmits two wavelength groups of a visible-light and the near-infrared light, and said image sensor comprises a first imaging unit for forming the image of light which does not pass through the first filter and passes through the second filter, and a second imaging unit for forming the image of light which passes through both of said first filter and said second filter.

2. The imaging device according to claim 1 further comprising a signal reading unit for reading a video and picture signal from said image sensor, wherein said signal reading unit is configured to separately read out video and picture signals from said first imaging unit and said second imaging unit.

3. The imaging device according to claim 1, wherein relative positions of said filters are fixed against said image sensor.

4. The imaging device according to claim 1, wherein said first filter is arranged inside said optical system, and the second filter is arranged outside said optical system.

5. The imaging device according to claim 1 comprising a translucent substrate arranged in a direction perpendicular to an optical axis of said optical system, wherein said first filter is a near-infrared light shielding film formed on said substrate.

6. The imaging device according to claim 5, wherein said substrate has a configuration which an area without forming the near-infrared light shielding film is cut.

7. The imaging device according to claim 6, wherein a normal line intersects said optical axis at an angle on a cut plane made by cutting said substrate.

8. The imaging device according to claim 7, wherein a light shielding film for shielding all lights is formed on said cut plane.

9. The imaging device according to claim 1, wherein a clear filter for transmitting all lights is arranged on an imaging plane of said first imaging unit, and the color filter is also arranged on the imaging plane of said second imaging unit.

10. The imaging device according to claim 1, wherein said second filter transmits lights of wavelength groups of 400 nm to 650 nm, and 800 nm to 850 nm, respectively.

11. The imaging device according to claim 1, wherein said first filter shields the light having the wavelength of 650 nm or more.

12. The imaging device according to claim 1, wherein said imaging device takes the images in a fixed focus method.

13. The imaging device according to claim 1, wherein said imaging device has auto focus function.
